(19) United States
(12) Patent Application Publication
(10) Pub. No.: US 2003/0224659 A1
(43) Pub. Date: Dec. 4, 2003

(54) Connector and housing assembly

(75) Inventor: Che-Chia Chang, Taipei (TW)

Correspondence Address: BRUCE H. TROXELL, SUITE 1404, 5205 LEESBURG PIKE, FALLS CHURCH, VA, 22041, US

(73) Assignee: COMAX TECHNOLOGY INC.

(21) Appl. No.: 10/156,053

(22) Filed: May 29, 2002

(51) Int. Cl. H01R 13/40; H01R 13/405

(52) U.S. Cl. 439/598; 439/736

(57) ABSTRACT

A connector assembly comprises a connector body, a plurality of conductive wires connected to the connector body, and a housing enclosing the conductive wires. The housing is fabricated by direct molding on the connector body so that the fabricated housing is directly fixed to the connector body. During molding of the housing in a mold cavity, a plurality of slots arranged in the connector body communicate with the interior of the mold cavity in which a molding compound is introduced to fabricate the housing. The molding compound therefore flows into the slots of the connector body, so that the fabricated housing encloses the conductive wires and is fixedly attached to the connector body by engaging into the slots thereof.

### BACKGROUND OF THE INVENTION

1. Field of The Invention

The invention relates to an electrical connector assembly. More particularly, the present invention relates to an electrical connector assembly in which the housing can be directly fixed to the connector body.

2. Description of Related Art

As shown in FIG. 1, a conventional connector assembly comprises a connector body 10, a plurality of conductive wires 18, and a housing 14. Conventionally, the housing 14 is separately fabricated, and then mounted and fixedly attached to the connector body 10. Therefore, specific fixing device 22 such as screws and bolt assembly must be provided to attach the housing 14 to the connector body 10.

With the conventional connector assembly, additional processes are thus necessary to accommodate the housing 14 and the connector body 10 with the fixing device 22.

A connector assembly that can be fabricated by a manufacture process of lower cost and better adhesion between housing and connector body is therefore desired.

### SUMMARY OF THE INVENTION

An aspect of the present invention is to provide a connector assembly in which separate fixing devices between the housing and the connector body are not needed, so that the manufacture cost of the connector assembly can be reduced.

Another aspect of the present invention is to provide a connector assembly in which the housing is fabricated directly fixed to the connector body such that specific steps for fixedly attaching the housing to the connector body are not required.

To attain at least the foregoing objectives a connector assembly of the invention comprises a connector body, a plurality of conductive wires connected to the connector body, and a housing. The connector body includes a plurality of slots specifically arranged for housing-attachment purpose. The housing is fabricated by directly molding it onto the connector body so that the housing, once fabricated, is directly fixed attached to the connector body by engaging in the slots of the connector body. This can be achieved by arranging the connector body in a mold with the slots communicating with an interior of the mold cavity. When molding compound is introduced in the mold cavity to form the housing, the molding compound can therefore flow into the slots of the connector body. A dam may be further arranged on the connector body to prevent any overflow of the molding compound into the connector body where the wires or contact terminals enter the connector body. As a result, the fabricated housing has protruding portions that are engaged in the sloes of the connector body. Once fabricated, the housing is therefore directly fixed Attached to the connector body.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view schematically illustrating a conventional connector assembly ; and

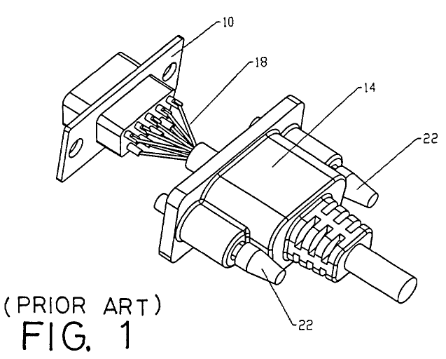

FIG. 2 is a perspective view schematically illustrating a conventional assembly according the an embodiment of the present invention.

### DETAILED DESCRIPTION OF THE PREFERRED EMBODIMENTS

The following detailed description of the embodiments and examples of the present invention with reference to the accompanying drawings is only illustrative of specific structures and ways of making of the present invention, and does not limit the scope of the present invention. Wherever possible in the description, like reference numerals will refer to like elements and parts unless otherwise illustrated.

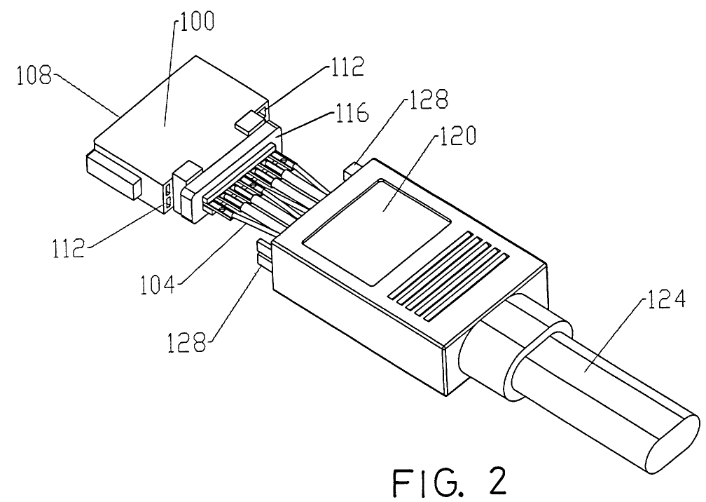

Referring now to FIG. 2, a perspective view schematically shows a connector assembly fabricated according to an embodiment of the present invention. As shown in FIG. 2, the connector assembly of the invention comprises a connector body 100, a cable 124 that encloses a plurality of conductive wires and or contact terminals 104, and a housing 120.

The conductive wires 104 electrically connect to contact terminals included in the connector body 100. The connector assembly thus can electrically connect various electrical devices (not sown), wherein at least one electrical device is electrically connected by engaging to a front side 108 of the connector body 100, for example.

The housing 120 encloses and protects the connection between the conductive wires 104 and the connector body 100. As shown in FIG. 2, the connector body 100 of the invention is provided 120 can be thereby directly fixedly attached to the connector body 100.

The housing 120 may be made of any materials appropriate to the purpose of protecting and housing the conductive wires 104. In a preferred embodiment of the invention, the housing 120 is made of, for example, polymer material formed by molding.

When fabricated by molding, the connector body 100 and conductive wires 104 are mounted onto a mold tool with the slots communicating with the interior of a mold cavity. When injected in the mold cavity to form the housing 120, a molding compound can therefore flow into the slots 112 of the connector body 100. A dam 116may be further arranged on the connector body 100 to prevent overflow of the molding compound over parts of the connector body 100 that are undesired The dam effectively prevents molding material from entering the connector body and covering the contact terminals which would inhibit the connector from working properly. As a result, the housing 120 once fabricated encloses the conductive wires 104 and is favorably fixedly attached to the connector body 100 by having portions 128 tightly fitted in the slots 112. Hence, additional fixing devices and steps for attaching the housing to the connector body are no longer needed.

FIG. 2 schematically illustrates a specific arrangement if the slots 112 within the connector body 100. It should be apparent to those skilled in the art that other arrangements of the slots with other shapes in the connector body 100 are possible in the purpose of fabricating a housing directly fixedly attached to the connector body. More particularly, the slots 112 of the connector body can be designed to have, for example, specific shape to obtain a better attachment of the housing to the connector body. In addition, the slots 112 can be arranged at locations on the connector body 100 that are different from the illustration of FIG. 2 to obtain improved attachment points.

In conclusion, the present invention provides a connector assembly in which the housing once fabricated is directly fixedly attached to the connector body, and no additional fixing devices are necessary. The manufacture time and manufacture cost therefore can be favorably reduced.

It will be apparent to those skilled in the art that various modifications and variations can be made to the structure and operations of the present invention without departing from the scope or spirit of the invention.

What is claimed is:

1. A connector assembly comprising:
a connector body, wherein the connector includes a plurality of slots arranged for attachment purpose;
a plurality of conductive wires connected to the connector body; and
a housing enclosing the conductive wires, the housing is fixedly attached to the connector body by having a plurality of protruding portions directly engaged into the slots

2. The connector assembly of claim 1, wherein the housing is fabricated by direct molding on the connector body.

3. The connector assembly of claim 2, wherein the housing once fabricated is directly fixedly attached to the connector.

4. The connector assembly of claim 2, wherein the housing further includes a dam member used to prevent an overflow of a molding compound over the connector body during molding.

5. A method for fabricating a housing for connector assembly, comprising:
providing a connector body connected to a plurality of conductive wires, wherein the connector body includes a plurality if slots and a dam member for preventing the overflow of a molding compound; arranging the connector body and the conductive wires in a mold cavity; and introducing a molding compound in the mold cavity to form the housing wherein the molding compound further flows into the slots so that the fabricated housing is directly fixedly attached to the connector body.
